(19) United States
(12) Patent Application Publication
(10) Pub. No.: US 2017/0045785 A1
(43) Pub. Date: Feb. 16, 2017

(54) ARRAY SUBSTRATE AND LIQUID CRYSTAL DISPLAY DEVICE

(71) Applicant: Shenzhen China Star Optoelectronics Technology Co., Ltd., Shenzhen, Guangdong (CN)

(72) Inventor: Zuming DENG, Shenzhen, Guangdong (CN)

(73) Assignee: Shenzhen China Star Optoelectronics Technology Co., Ltd., Shenzhen, Guangdong (CN)

(21) Appl. No.: 14/443,982

(22) PCT Filed: Apr. 16, 2015
(86) PCT No.: PCT/CN2015/076724

§ 371 Date: May 19, 2015

(30) Foreign Application Priority Data
Apr. 7, 2015 (CN) 201510160938.4

(51) Int. Cl. G02F 1/1343; G02F 1/1362; G02F 1/1335

(52) U.S. Cl. CPC G02F 1/134309; G02F 1/133514; G02F 1/13439; G02F 1/136286; G02F 2201/123; G02F 2201/121; G02F 1/1368

(57) ABSTRACT

An array substrate and a liquid crystal display device are disclosed. The array substrate is a rectangular substrate extended along an x-axis direction and a y-axis direction, and the x-axis direction and the y-axis direction are perpendicular with each other. The array substrate includes multiple pixel electrodes. Each pixel electrode includes a first portion and a second portion. The first portion is disposed aslant along a first direction. The first direction is different from the x-axis direction and the y-axis direction. The second portion is disposed aslant along a second direction. The second direction is different from the x-axis direction, the y-axis direction and the first direction. The present invention can improve the visibility of the picture on the liquid crystal display device when using polarized sunglasses to watch the liquid crystal display device so as to decrease dependence of the viewing angle.

### BACKGROUND OF THE INVENTION

1. Field of the Invention

The present invention relates to a liquid crystal display technology field, and more particular to an array substrate and a liquid crystal display device.

2. Description of Related Art

In a liquid crystal display (LCD) device, a liquid crystal panel such as an active matrix type includes a thin-film-transistor (TFT) array substrate having a pixel area, a color filter substrate disposed oppositely to the TFT array substrate, and a liquid crystal layer disposed between the TFT array substrate and the color filter substrate. In the pixel area, multiple TFTs function as switches are formed. In the active type liquid crystal panel, through inputting a voltage to the pixel electrode by the TFT switch so as to generate an electric field between the pixel electrode and a common electrode, and applying the electric field to the liquid crystal layer, the light transmittance coefficient is adjusted in order to display a picture.

When watching the LCD device at the outdoor using polarized sunglasses, and when a light transmission axis of the LCD device and a light transmission axis of the polarized sunglasses are the same, an image on the LCD device can be effectively observed. In the conventional Fringe Field Switching (FFS) mode, the pixel electrode is designed as a rectangular shape having a side being parallel with an X-axis. The light transmission axis of the pixel area is parallel with a long side or a short side of the pixel electrode. The light transmission axis of the LCD device and the light transmission axis of the polarized sunglasses are sometimes inconsistent such that the image on the LCD device is hard to be observed.

### SUMMARY OF THE INVENTION

The main technology problem solved by the present invention is to provide an array substrate and a liquid crystal display device, which can improve the visibility of the picture on the liquid crystal display device when using polarized sunglasses to watch the liquid crystal display device so as to decrease dependence of the viewing angle.

In order to solve the above technology problem, a technology solution of the present invention is: an array substrate, wherein, the array substrate is a rectangular substrate extended along a x-axis direction and a y-axis direction, and the x-axis direction and the y-axis direction are perpendicular with each other, the array substrate comprising: multiple pixel electrodes disposed on the array substrate, wherein, each pixel electrode includes: a first portion disposed aslant along a first direction, wherein, the first direction is different from the x-axis direction and the y-axis direction; the first direction is tilted with respect to the x-axis direction and a first included angle is formed between the first direction and the x-axis direction, wherein, the first portion includes: at least one first trunk portion disposed aslant along the first direction; and multiple first branch portions, wherein, the multiple first branch portions are parallel with each other and are connected with the first trunk portion; a second portion disposed aslant along a second direction, wherein, the second direction is different from the x-axis direction, the y-axis direction and the first direction; the second direction is tilted with respect to the x-axis direction and a second included angle is formed between the second direction and the x-axis direction, wherein, the second portion includes: at least one second trunk portion disposed aslant along the second direction; and are connected with the first trunk portion; and multiple second branch portions, wherein, the multiple second branch portions are parallel with each other and are connected with the second trunk portion; wherein, in the multiple first branch portions which are parallel with each other, spaces of two adjacent first portions are all equal; in the multiple second branch portions which are parallel with each other, spaces of two adjacent second portions are all equal.

Wherein, the first included angle and the second included angle are supplementary.

Wherein, the first portion of each pixel electrode includes two first trunk portions which are parallel with each other; the two first trunk portions are respectively disposed aslant along the first direction; the multiple first branch portions are respectively disposed between the two first trunk portions and are connected with the two first trunk portions; and the second portion of each pixel electrode includes two second trunk portions which are parallel with each other; the two second trunk portions are respectively disposed aslant along the second direction and are respectively connected with the two first trunk portions; the multiple second branch portions are respectively disposed between the two second trunk portions and are connected with the two second trunk portions.

Wherein, the multiple second branch portions and the multiple first branch portions are parallel with each other.

Wherein, the array substrate further includes: multiple scanning lines, and each scanning line includes: multiple first scanning line sections; and multiple second scanning line sections; wherein, the first scanning line sections and the second scanning line sections are disposed alternately and connected together; the multiple first scanning line sections are respectively disposed aslant along the second direction; the multiple second scanning line sections are respectively disposed aslant along the first direction; multiple data lines, and each data line includes: multiple first data line sections; multiple second data line sections; and multiple third data line sections; wherein, the multiple first data line sections, the multiple second data line sections and the multiple third data line sections are disposed alternately and connected together according to a sequence of the first data line section, the second data line section, the first data line section and the third data line section; the multiple first data line sections are respectively parallel with the multiple first branch portions; the multiple second data line sections are respectively disposed aslant along the second direction, and the multiple third data line sections are respectively disposed aslant along the first direction.

Wherein, the second data line section is overlapped with a portion of the first scanning line section, and the second data line section and the first scanning line section are located at different layers; the third data line section is overlapped with a portion of the second scanning line section, and the third data line section and the second scanning line section are located at different layers.

In order to solve the above technology problem, another technology solution of the present invention is: an array substrate, wherein, the array substrate is a rectangular substrate extended along a x-axis direction and a y-axis direction, and the x-axis direction and the y-axis direction are perpendicular with each other, the array substrate comprising: multiple scanning lines, and each scanning line includes: multiple first scanning line sections; and multiple second scanning line sections; wherein, the first scanning line sections and the second scanning line sections are disposed alternately and connected together; the multiple first scanning line sections are respectively disposed aslant along a second direction; the multiple second scanning line sections are respectively disposed aslant along a first direction, wherein, the first direction is different from the x-axis direction and the y-axis direction; the first direction is tilted with respect to the x-axis direction and a first included angle is formed between the first direction and the x-axis direction; the second direction is different from the x-axis direction, the y-axis direction and the first direction; the second direction is tilted with respect to the x-axis direction and a second included angle is formed between the second direction and the x-axis direction; multiple data lines, and each data line includes: multiple first data line sections; multiple second data line sections; and multiple third data line sections; wherein, the multiple first data line sections, the multiple second data line sections and the multiple third data line sections are disposed alternately and connected together according to a sequence of the first data line section, the second data line section, the first data line section and the third data line section; the multiple first data line sections are disposed aslant with respect to the y-axis direction; the multiple second data line sections are respectively disposed aslant along the second direction, and the multiple third data line sections are respectively disposed aslant along the first direction; and multiple pixel electrodes disposed on the array substrate, wherein, each pixel electrode includes: a first portion disposed aslant along a first direction, wherein, the first portion includes: at least one first trunk portion disposed aslant along the first direction; and multiple first branch portions, wherein, the multiple first branch portions are parallel with each other and are connected with the first trunk portion; and a second portion disposed aslant along a second direction, wherein, the second portion includes: at least one second trunk portion disposed aslant along the second direction, and are connected with the first trunk portion; and multiple second branch portions, wherein, the multiple second branch portions are parallel with each other and are connected with the second trunk portion.

In order to solve the above technology problem, another technology solution of the present invention is: a liquid crystal display device, comprising: an array substrate, wherein, the array substrate is a rectangular substrate extended along a x-axis direction and a y-axis direction, and the x-axis direction and the y-axis direction are perpendicular with each other, the array substrate comprising: multiple pixel electrodes disposed on the array substrate, wherein, each pixel electrode includes: a first portion disposed aslant along a first direction, wherein, the first direction is different from the x-axis direction and the y-axis direction; the first direction is tilted with respect to the x-axis direction and a first included angle is formed between the first direction and the x-axis direction, wherein, the first portion includes: at least one first trunk portion disposed aslant along the first direction; and multiple first branch portions, wherein, the multiple first branch portions are parallel with each other and are connected with the first trunk portion; a second portion disposed aslant along a second direction, wherein, the second direction is different from the x-axis direction, the y-axis direction and the first direction; the second direction is tilted with respect to the x-axis direction and a second included angle is formed between the second direction and the x-axis direction, wherein, the second portion includes: at least one second trunk portion disposed aslant along the second direction; and are connected with the first trunk portion; and multiple second branch portions, wherein, the multiple second branch portions are parallel with each other and are connected with the second trunk portion; wherein, in the multiple first branch portions which are parallel with each other, spaces of two adjacent first portions are all equal; in the multiple second branch portions which are parallel with each other, spaces of two adjacent second portions are all equal; a color filter substrate disposed oppositely to the array substrate; and a liquid crystal layer disposed between the array substrate and the color filter substrate; wherein, the array substrate also includes a common electrode; the pixel electrode and the common electrode apply a transverse electric field to the liquid crystal layer.

Comparing to the conventional art, in the present invention, the pixel electrode on the array substrate is designed to be tilted such that the pixel electrode is tilted along a direction which is different from x-axis and y-axis. Therefore, the present invention can improve the visibility of the picture on the liquid crystal display device when using polarized sunglasses to watch the liquid crystal display device so as to decrease dependence of the viewing angle.

### BRIEF DESCRIPTION OF THE DRAWINGS

FIG. 1 is a schematic diagram of a pixel electrode of an array substrate according to an embodiment of the present invention;

FIG. 2 is a schematic diagram of an array substrate according to an embodiment of the present invention;

FIG. 3 is schematic relationship diagram of a first direction, a second direction, an x axis and a y axis according to an embodiment of the present invention; and

FIG. 4 is a schematic diagram of an LCD device according to an embodiment of the present invention.

### DETAILED DESCRIPTION OF THE PREFERRED EMBODIMENT

The following content combines figures and embodiments for detail description of the present invention.

The embodiment of the present invention provides an array substrate. The array substrate is a rectangular substrate extended along an x-axis direction and a y-axis direction, wherein, the x-axis direction and the y-axis direction are perpendicular with each other, the array substrate includes multiple pixel electrodes disposed on the array substrate.

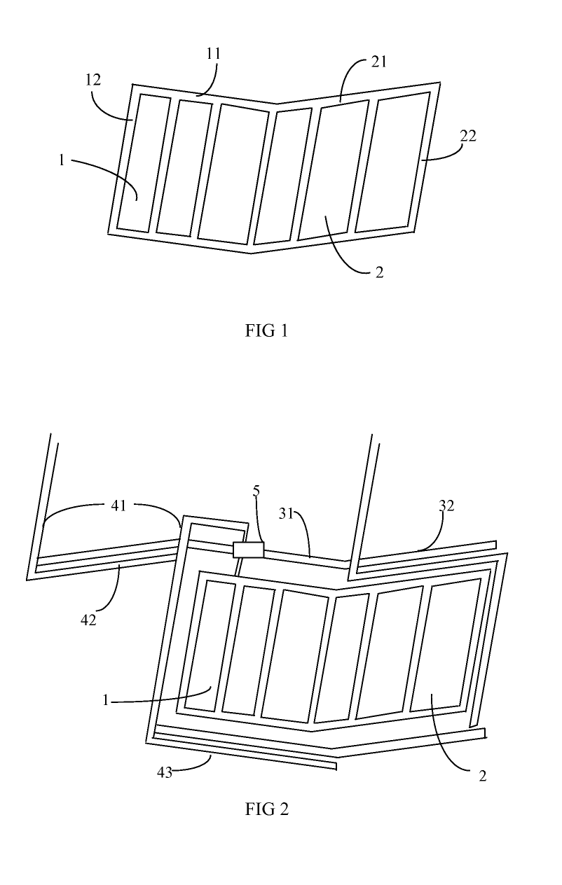

As shown in FIG. 1, each of the pixel electrodes includes a first portion 1 and a second portion 2, wherein, the first portion 1 is disposed aslant along a first direction. The first direction is different from the x-axis direction and the y-axis direction. That is, the first direction is not parallel with the x-axis and the y-axis. The first direction is tilted with respect to the x-axis, and a first included angle is formed between the first direction and the x-axis. The disposition that the first direction is tilted with respect to the x-axis means that the first included angle between the first direction and the x-axis is smaller than 45 degree. In some embodiments of the present invention, the first angle can be smaller than 20 degrees or smaller than 15 degrees or smaller than 10 degrees, 15˜20 degrees or 10˜15 degrees.

The second portion 2 is disposed aslant along a second direction. The second direction is different from the x-axis direction, the y-axis direction and the first direction. That is, the second direction is not parallel with the x-axis and a y-axis. At the same time, the second direction is not parallel with the first direction. The second direction is tilted with respect to the x-axis direction and a second included angle is existed between the second direction and the x-axis direction. The second direction is also closed to the x-axis. In some embodiment, the second included angle can be 160˜180 degrees, 165˜180 degrees, 170˜180 degrees, 165˜170 degrees or 160˜165 degrees and son on.

Wherein, the first portion 1 includes at least one trunk portion 11 and multiple first branch portions 12. The first trunk portion 11 is disposed aslant along the first direction. The multiple first branch portions 12 are parallel with each other and are connected with the first trunk portion 11. The second portion 2 includes at least one second trunk portion 21 and multiple second branch portions 22. The second trunk portion 21 is disposed aslant along the second direction and connected with the first trunk portion 11.

Wherein, in one embodiment of the present invention, the first branch portions 12 and the second branch portions 22 are parallel with each other. In another embodiment of the present invention, for the multiple first branch portions 12 which are parallel with each other, distances of adjacent two of the multiple first branch portions 12 are all equal. For the multiple second branch portions 22 which are parallel with each other, distances of adjacent two of the multiple second branch portions 22 are all equal.

In another embodiment of the present invention, for the multiple first branch portions 12 which are parallel with each other, distances of adjacent two of the first branch portions 12 are all equal. For the multiple second branch portions 22 which are parallel with each other, distances of adjacent two of the second branch portions 22 are all equal. Besides, distances of adjacent two of the first branch portions 12 and distances of adjacent two of the second branch portions 22 are equal. The first branch portions 12 are parallel with the second branch portions 22. In the above embodiments, the number of the first branch portions 12 of the first portion 1 and the number of the second branch portions 22 of the second portion 2 are the same.

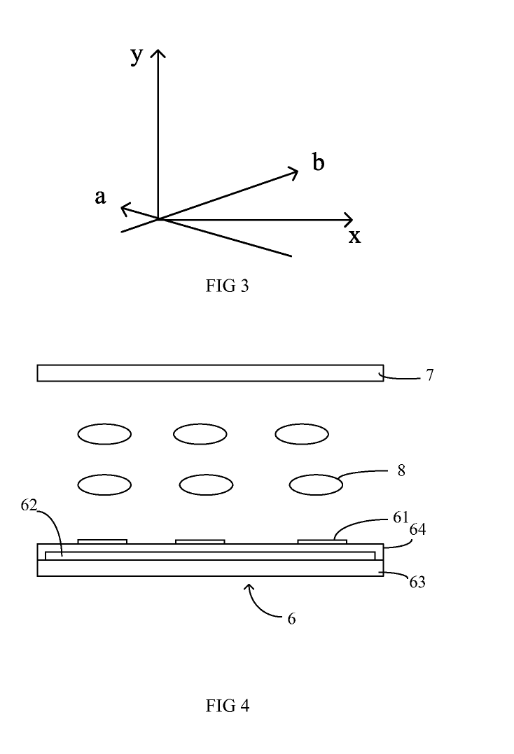

Comparing to the conventional art, in the present invention, the pixel electrode on the array substrate is designed to be tilted such that the pixel electrode is tilted along a direction which is different from x-axis and y-axis. Therefore, the present invention can improve the visibility of the picture on the liquid crystal display device when using polarized sunglasses to watch the liquid crystal display device so as to decrease dependence of the viewing angle. Besides, the pixel electrodes of the present invention are divided into the first portion 1 and the second portion 2 which are tilted along different directions, that is, forming a two-domain structure in order to improve the color shift situation in large viewing angles at left side and right side.

Wherein, as shown in FIG. 3, the first included angle and the second included angle are supplementary. That is, a straight line on the first direction “a” and a straight line on a second direction “b” are symmetric and using the x-axis as a symmetric axis. In the present invention, when the second included angle is 160 degrees, the first included angle is 20 degrees, and when second included angle is 165 degrees, the first included angle is 15 degrees. In the present invention, the first included angle and the second included angle are supplementary, and the present invention can improve the visibility of the picture on the liquid crystal display device when using polarized sunglasses to watch the liquid crystal display device so as to decrease dependence of the viewing angle.

Wherein, as shown in FIG. 1, the first portion 1 of each pixel electrode includes two first trunk portions 11 which are parallel with each other. The two first trunk portions 11 are respectively disposed aslant along a first direction. The multiple first branch portions 12 are respectively disposed between the two first trunk portions 11 and the multiple first branch portions 12 are connected with the two first trunk portions 11. The second portion 2 of each pixel electrode includes two second trunk portion 21 and multiple second branch portions 22. The two second trunk portions 21 are disposed aslant along a second direction and are respectively connected with the two first trunk portions 11. The multiple second branch portions 22 are respectively disposed between the two second trunk portions 21 and are connected with the two second trunk portions 21. In another embodiment, three or more first trunk portions 11 or second trunk portions 21 can be disposed.

Wherein, the multiple second branch portions 22 and the multiple first branch portions 12 are parallel with each other. That is, in one pixel electrode, trunk portion of the pixel electrode is divided into two portions extended at different directions, and all branch portions are parallel with each other. In one embodiment of the present invention, in multiple first branch portions 12 and multiple second branch portions 22 which are parallel with each other, spaces between two adjacent branch portions are all equal. In the embodiment of the present invention, the multiple second branch portions 22 and the multiple first branch portions 12 are parallel with each other so that the visibility of the picture on liquid crystal display device can be improved.

Wherein, as shown in FIG. 2, the array substrate further includes multiple scanning lines and multiple data lines, each scanning line includes multiple first scanning line sections 31 and multiple second scanning line sections 32. The first scanning line sections 31 and the second scanning line sections 32 are disposed alternately and connected together. The multiple first scanning line sections 31 are respectively disposed aslant along the second direction. The multiple second scanning line sections 32 are respectively disposed aslant along the first direction. Each data line includes multiple first data line sections 41, multiple second data line sections 42 and multiple third data line sections 43. Wherein, the multiple first data line sections 41, the multiple second data line sections 42 and the multiple third data line sections 43 are disposed alternately and connected together according to a sequence of the first data line section 41, the second data line section 42, the first data line section 41 and the third data line section 43. The multiple first data line sections are respectively parallel with the multiple first branch portions. The multiple second data line sections 42 are respectively disposed aslant along the second direction, and the multiple third data line sections 43 are respectively disposed aslant along the first direction.

The multiple data lines and multiple scanning lines are crossed with each other to make the array substrate to be divided into multiple closed regions. The pixel electrodes are respectively disposed in the closed regions. In one embodiment of the present invention, a length of the second data line section 42 and a length of the first scanning line section 31 are the same, and a length of the third data line section 43 and a length of the second scanning line section 32 are the same. Accordingly, the arrangement of the data lines and the scanning lines are more reasonable in order to increase the space utilization rate of the array substrate.

Wherein, the second data line section 42 is overlapped with a portion of the first scanning line section 31, and the second data line section 42 and the first scanning line section 31 are located at different layers. The third data line section 43 is overlapped with a portion of the second scanning line section 32, and the third data line section 43 and the second scanning line section 32 are located at different layers. Because the array substrate includes multiple insulation layers, through disposing the second data line section 42 and the first scanning line section 31 at same positions of different layers and disposing the third data line section 43 and the second scanning line section 32 at same positions of different layers, the space utilization rate is improved.

Wherein, the array substrate further includes a thin-film transistor 5. A drain electrode of the thin-film transistor 5 is connected with the first trunk portion or the second trunk portion. A source electrode of the thin-film transistor 5 is connected with the data line. A gate electrode of the thin-film transistor 5 is connected with the scanning line. Wherein, in one embodiment of the present invention, the thin-film transistor 5 is disposed at an intersection location of the first data line section 41 and the second scanning line section 32.

As shown in FIG. 2, another embodiment of the present invention provides an array substrate. The array substrate is a rectangular substrate extended along an x-axis direction and a y-axis direction. Wherein, the x-axis direction and the y-axis direction are perpendicular with each other. The array substrate includes multiple scanning lines, multiple data lines and multiple pixel electrodes.

Wherein, each scanning line includes multiple first scanning line sections 31 and multiple second scanning line sections 32. The first scanning line sections 31 and the second scanning line sections 32 are disposed alternately and connected together. The multiple first scanning line sections 31 are respectively disposed aslant along the second direction. The multiple second scanning line sections 32 are respectively disposed aslant along the first direction. The first direction is not equal to the x-axis direction and the y-axis direction. The first direction is tilted with respect to the x-axis, and a first included angle is formed between the first direction and the x-axis.

The second direction is different from the x-axis direction, the y-axis direction and the first direction. The second direction is tilted with respect to the x-axis direction and a second included angle is formed between the second direction and the x-axis direction.

Each data line includes multiple first data line sections 41, multiple second data line sections 42 and multiple third data line sections 43. Wherein, the multiple first data line sections 41, the multiple second data line sections 42 and the multiple third data line sections 43 are disposed alternately and connected together according to a sequence of the first data line section 41, the second data line section 42, the first data line section 41 and the third data line section 43. The multiple first data line sections are disposed aslant with respect to the y-axis direction, that is, a direction of the first data line section is more closed to the y-axis, and an included angle between the first data line section and the y-axis is smaller than 45 degrees. The multiple second data line sections 42 are respectively disposed aslant along the second direction, and the multiple third data line sections 43 are respectively disposed aslant along the first direction.

Each of the pixel electrodes includes a first portion 1 and a second portion 2, wherein, the first portion 1 is disposed aslant along the first direction. The second portion 2 is disposed aslant along the second direction. Wherein, the first portion 1 includes at least one trunk portion 11 and multiple first branch portions 12. The first trunk portion is disposed aslant along the first direction. The multiple first branch portions are parallel with each other and are connected with the first trunk portion. The second portion 2 includes at least one second trunk portion 21 and multiple second branch portions 22. The second trunk portion 21 is disposed aslant along the second direction and connected with the first trunk portion 11. The multiple second branch portions are parallel with each other and are connected with the second trunk portion.

Comparing to the conventional art, in the present invention, the pixel electrode on the array substrate is designed to be tilted such that the pixel electrode is tilted along a direction which is different from x-axis and y-axis. Therefore, the present invention can improve the visibility of the picture on the liquid crystal display device when using polarized sunglasses to watch the liquid crystal display device so as to decrease dependence of the viewing angle. Besides, one pixel electrode of the present invention are divided into the first portion 1 and the second portion 2 which are tilted along different directions, that is, forming a two-domain structure in order to improve the color shift situation in large viewing angles at left side and right side.

Wherein, the first included angle and the second included angle are supplementary.

The first portion 1 of each pixel electrode includes two first trunk portions 11 which are parallel with each other. The two first trunk portions 11 are respectively disposed aslant along a first direction. The multiple first branch portions 12 are respectively disposed between the two first trunk portions 11 and the multiple first branch portions 12 are connected with the two first trunk portions 11. The second portion 2 of each pixel electrode includes two second trunk portions 21 and multiple second branch portions 22. The two second trunk portions 21 are disposed aslant along a second direction and are respectively connected with the two first trunk portions 11. The multiple second branch portions 22 are respectively disposed between the two second trunk portions 21 and are connected with the two second trunk portions 21.

Wherein, the second data line section 42 is overlapped with a portion of the first scanning line section 31, and the second data line section 42 and the first scanning line section 31 are located at different layers. The third data line section 43 is overlapped with a portion of the second scanning line section 32, and the third data line section 43 and the second scanning line section 32 are located at different layers.

As shown in FIG. 4, another embodiment of the present invention also provides a liquid crystal display device. The device includes an array substrate 6 as the above embodiments, a color filter substrate 7 disposed oppositely to the array substrate 6 and a liquid crystal layer 8 disposed between the array substrate 6 and the color filter substrate 7. The array substrate 6 further includes a common electrode 62. A pixel electrode 61 and the common electrode 62 apply a transverse electric field to the liquid crystal layer 8. Wherein, the array substrate 6 also includes a glass substrate 63. The common electrode 62 and the pixel electrode 61 are disposed on the glass substrate 63. The common electrode 62 and the glass electrode 63 are spaced apart by an insulation layer 64.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. An array substrate, wherein, the array substrate is a rectangular substrate extended along an x-axis direction and a y-axis direction, and the x-axis direction and the y-axis direction are perpendicular with each other, the array substrate comprising:
multiple pixel electrodes disposed on the array substrate, wherein, each pixel electrode includes:
a first portion disposed aslant along a first direction, wherein, the first direction is different from the x-axis direction and the y-axis direction; the first direction is tilted with respect to the x-axis direction and a first included angle is formed between the first direction and the x-axis direction, wherein, the first portion includes:
at least one first trunk portion disposed aslant along the first direction; and
multiple first branch portions, wherein, the multiple first branch portions are parallel with each other and are connected with the first trunk portion;
a second portion disposed aslant along a second direction, wherein, the second direction is different from the x-axis direction, the y-axis direction and the first direction; the second direction is tilted with respect to the x-axis direction and a second included angle is formed between the second direction and the x-axis direction, wherein, the second portion includes:
at least one second trunk portion disposed aslant along the second direction; and are connected with the first trunk portion; and
multiple second branch portions, wherein, the multiple second branch portions are parallel with each other and are connected with the second trunk portion;
wherein, in the multiple first branch portions which are parallel with each other, spaces of two adjacent first portions are all equal; in the multiple second branch portions which are parallel with each other, spaces of two adjacent second portions are all equal.

2. The array substrate according to claim 1, wherein, the first included angle and the second included angle are supplementary.

3. The array substrate according to claim 2, wherein, the first portion of each pixel electrode includes two first trunk portions which are parallel with each other; the two first trunk portions are respectively disposed aslant along the first direction; the multiple first branch portions are respectively disposed between the two first trunk portions and are connected with the two first trunk portions; and
the second portion of each pixel electrode includes two second trunk portions which are parallel with each other; the two second trunk portions are respectively disposed aslant along the second direction and are respectively connected with the two first trunk portions; the multiple second branch portions are respectively disposed between the two second trunk portions and are connected with the two second trunk portions.

4. The array substrate according to claim 3, wherein, the multiple second branch portions and the multiple first branch portions are parallel with each other.

5. The array substrate according to claim 1, wherein, the array substrate further includes:
multiple scanning lines, and each scanning line includes:
multiple first scanning line sections; and
multiple second scanning line sections;
wherein, the first scanning line sections and the second scanning line sections are disposed alternately and connected together; the multiple first scanning line sections are respectively disposed aslant along the second direction; the multiple second scanning line sections are respectively disposed aslant along the first direction;
multiple data lines, and each data line includes:
multiple first data line sections;
multiple second data line sections; and
multiple third data line sections;
wherein, the multiple first data line sections, the multiple second data line sections and the multiple third data line sections are disposed alternately and connected together according to a sequence of the first data line section, the second data line section, the first data line section and the third data line section; the multiple first data line sections are respectively parallel with the multiple first branch portions; the multiple second data line sections are respectively disposed aslant along the second direction, and the multiple third data line sections are respectively disposed aslant along the first direction.

6. The array substrate according to claim 5, wherein, the second data line section is overlapped with a portion of the first scanning line section, and the second data line section and the first scanning line section are located at different layers; the third data line section is overlapped with a portion of the second scanning line section, and the third data line section and the second scanning line section are located at different layers.

7. An array substrate, wherein, the array substrate is a rectangular substrate extended along an x-axis direction and a y-axis direction, and the x-axis direction and the y-axis direction are perpendicular with each other, the array substrate comprising:
multiple scanning lines, and each scanning line includes:
multiple first scanning line sections; and
multiple second scanning line sections;
wherein, the first scanning line sections and the second scanning line sections are disposed alternately and connected together; the multiple first scanning line sections are respectively disposed aslant along a second direction; the multiple second scanning line sections are respectively disposed aslant along a first direction, wherein, the first direction is different from the x-axis direction and the y-axis direction; the first direction is tilted with respect to the x-axis direction and a first included angle is formed between the first direction and the x-axis direction; the second direction is different from the x-axis direction, the y-axis direction and the first direction; the second direction is tilted with respect to the x-axis direction and a second included angle is formed between the second direction and the x-axis direction;
multiple data lines, and each data line includes:
multiple first data line sections;
multiple second data line sections; and
multiple third data line sections;
wherein, the multiple first data line sections, the multiple second data line sections and the multiple third data line sections are disposed alternately and connected together according to a sequence of the first data line section, the second data line section, the first data line section and the third data line section; the multiple first data line sections are disposed aslant with respect to the y-axis direction; the multiple second data line sections are respectively disposed aslant along the second direction, and the multiple third data line sections are respectively disposed aslant along the first direction; and
multiple pixel electrodes disposed on the array substrate, wherein, each pixel electrode includes:
a first portion disposed aslant along a first direction, wherein, the first portion includes:
at least one first trunk portion disposed aslant along the first direction; and
multiple first branch portions, wherein, the multiple first branch portions are parallel with each other and are connected with the first trunk portion; and
a second portion disposed aslant along a second direction, wherein, the second portion includes:
at least one second trunk portion disposed aslant along the second direction, and are connected with the first trunk portion; and
multiple second branch portions, wherein, the multiple second branch portions are parallel with each other and are connected with the second trunk portion.

8. The array substrate according to claim 7, wherein, the first included angle and the second included angle are supplementary.

9. The array substrate according to claim 8, wherein, the first portion of each pixel electrode includes two first trunk portions which are parallel with each other; the two first trunk portions are respectively disposed aslant along the first direction; the multiple first branch portions are respectively disposed between the two first trunk portions and are connected with the two first trunk portions; and
the second portion of each pixel electrode includes two second trunk portions which are parallel with each other; the two second trunk portions are respectively disposed aslant along the second direction and are respectively connected with the two first trunk portions; the multiple second branch portions are respectively disposed between the two second trunk portions and are connected with the two second trunk portions.

10. A liquid crystal display device, comprising:
an array substrate, wherein, the array substrate is a rectangular substrate extended along an x-axis direction and a y-axis direction, and the x-axis direction and the y-axis direction are perpendicular with each other, the array substrate comprising:
multiple pixel electrodes disposed on the array substrate, wherein, each pixel electrode includes:
a first portion disposed aslant along a first direction, wherein, the first direction is different from the x-axis direction and the y-axis direction; the first direction is tilted with respect to the x-axis direction and a first included angle is formed between the first direction and the x-axis direction, wherein, the first portion includes:
at least one first trunk portion disposed aslant along the first direction; and
multiple first branch portions, wherein, the multiple first branch portions are parallel with each other and are connected with the first trunk portion;
a second portion disposed aslant along a second direction, wherein, the second direction is different from the x-axis direction, the y-axis direction and the first direction; the second direction is tilted with respect to the x-axis direction and a second included angle is formed between the second direction and the x-axis direction, wherein, the second portion includes:
at least one second trunk portion disposed aslant along the second direction; and are connected with the first trunk portion; and
multiple second branch portions, wherein, the multiple second branch portions are parallel with each other and are connected with the second trunk portion;
wherein, in the multiple first branch portions which are parallel with each other, spaces of two adjacent first portions are all equal; in the multiple second branch portions which are parallel with each other, spaces of two adjacent second portions are all equal;
a color filter substrate disposed oppositely to the array substrate; and
a liquid crystal layer disposed between the array substrate and the color filter substrate;
wherein, the array substrate also includes a common electrode; the pixel electrode and the common electrode apply a transverse electric field to the liquid crystal layer.

11. The liquid crystal display device according to claim 10, wherein, the first included angle and the second included angle are supplementary.

12. The liquid crystal display device according to claim 11, wherein, the first portion of each pixel electrode includes two first trunk portions which are parallel with each other; the two first trunk portions are respectively disposed aslant along the first direction; the multiple first branch portions are respectively disposed between the two first trunk portions and are connected with the two first trunk portions; and
the second portion of each pixel electrode includes two second trunk portions which are parallel with each other; the two second trunk portions are respectively disposed aslant along the second direction and are respectively connected with the two first trunk portions; the multiple second branch portions are respectively disposed between the two second trunk portions and are connected with the two second trunk portions.

13. The liquid crystal display device according to claim 12, wherein, the multiple second branch portions and the multiple first branch portions are parallel with each other.

14. The liquid crystal display device according to claim 10, wherein, the array substrate further includes:
multiple scanning lines, and each scanning line includes:
multiple first scanning line sections; and
multiple second scanning line sections;
wherein, the first scanning line sections and the second scanning line sections are disposed alternately and connected together; the multiple first scanning line sections are respectively disposed aslant along the second direction; the multiple second scanning line sections are respectively disposed aslant along the first direction;
multiple data lines, and each data line includes:
multiple first data line sections;
multiple second data line sections; and
multiple third data line sections;
wherein, the multiple first data line sections, the multiple second data line sections and the multiple third data line sections are disposed alternately and connected together according to a sequence of the first data line section, the second data line section, the first data line section and the third data line section; the multiple first data line sections are respectively parallel with the multiple first branch portions; the multiple second data line sections are respectively disposed aslant along the second direction, and the multiple third data line sections are respectively disposed aslant along the first direction.

15. The liquid crystal display device according to claim 14, wherein, the second data line section is overlapped with a portion of the first scanning line section, and the second data line section and the first scanning line section are located at different layers; the third data line section is overlapped with a portion of the second scanning line section, and the third data line section and the second scanning line section are located at different layers.
